(19) United States
(12) Patent Application Publication
(10) Pub. No.: US 2006/0182143 A1
(43) Pub. Date: Aug. 17, 2006

(54) System and method for filtering communications packets on electronic devices

(76) Inventor: HongQian Karen Lu, Austin, TX (US)

Correspondence Address: ANDERSON & JANSSON L.L.P., 9501 N. CAPITAL OF TX HWY #202, AUSTIN, TX, 78759, US

(21) Appl. No.: 11/352,882

(22) Filed: Feb. 13, 2006

Related U.S. Application Data
(60) Provisional application No. 60/652,342, filed on Feb. 11, 2005.

(51) Int. Cl. H04Q 7/24; H04J 3/16; H04Q 7/00; H04J 3/22

(52) U.S. Cl. 370/469; 370/328; 370/338

(57) ABSTRACT

A system and method for filtering communications packets on electronic devices. The system and method operable to receive a communications packet in a link layer protocol embedded in a data frame in a data frame protocol on the electronic device, to filter based on the first protocol header corresponds to a first protocol packet embedded in the data frame, to successively processing octets in the data frame by processing the octet according to the rules of the data frame protocol; upon processing octets comprising the first protocol header, passing the protocol header to a first protocol packet filter and in response to receiving a first protocol filter result indicative that the received packet should be dropped, skipping processing through the end of the data frame.

### CROSS-REFERENCE TO RELATED APPLICATIONS

This invention claims priority pursuant to 35 U.S.C. 119 of U.S. Provisional Patent Application Ser. No. 60/652,342, filed on Feb. 11, 2006. This Provisional Application is hereby incorporated by reference in its entirety.

### TECHNICAL FIELD

The present invention relates to the operation of network-based electronic devices, and more particularly, to systems and methods for filtering communications packets on such electronic devices.

### BACKGROUND OF THE INVENTION

One of the most vexing issues faced by the electronics industry, especially the electronic communications industry, is that the computer networks have become a favorite venue of various types of malfeasance.

One network security threat is the transmission of communications packets to a node on a network where the communications packets are undesirable to the node for some reason. That reason may, for example, be the repeated transmission of packets in an effort to disable the node.

Firewalls are examples of methods by which network nodes may be protected against attacks based on the transmission of communications packets. Firewalls can be implemented in hardware, software, or the combination of both. This work focuses on the software method. Firewall techniques include packet filter, application gateway, circuit-level gateway, and proxy server.

As the Internet grows, many small resource constrained devices join the Internet to provide services or to access resources over the Internet. One such example is the Network Smart Card which is a smart card with networking capabilities (Lu, H. K., Montgomery, M., and Ali, A., “Secure Networking Using a Resource Constraint Device,” U.S. patent application Ser. No. 10/848,738, the entire disclosure of which is incorporated herein by reference). Once joining the network, these embedded devices are exposed to the network security threats just like the other computers on the network. Therefore, they require security protections as well.

However, most existing firewalls are not suitable for small, embedded devices because of computing resource limitations due to the heavy resource burden imposed by such packet filters. Most prior art detection methods are based on statistics of the packets that indicate a probability of network-based attack based on certain characteristics, for example, probabilities or distributions of certain types of packets, open port numbers, service requests, errors, or signatures (or patterns) of the packets flow (i.e., particular patterns of packets or sequences of packets). These methods require the understanding of normal or abnormal packets probabilities or signatures and being able to separate normal and abnormal packet flows. These systems need to be trained and be adaptable to changes of the statistics or signatures. Implementation-wise, most existing methods for host computers run in a separate processor or a separate task. This would consume too many resources for resource-constrained network devices.

One way for a device to join a network is to use the Point-to-Point Protocol (PPP) to connect to another computer or a network, which has the Internet connection. For example, in order to get an Internet connection, a PDA connects to a host computer via Bluetooth or a mobile phone connects to a GPRS network. The PDA or the mobile phone use PPP as the link layer to dial into the host computer or the GPRS network. PPP frames encapsulate higher level protocol packets, e.g., the PPP packets may encapsulate Internet protocols, such as TCP/IP, UDP, or other protocols. The PPP protocol specifies three framing techniques for use with various media (described in RFC 1662, “PPP in HDLC-like Framing” Network Working Group, 1994). One of the framing techniques is the Asynchronous High-Level Data Link Control (AHDLC). The AHDLC is used for all asynchronous lines, such as modems used on computers.

From the foregoing it will be apparent that there is still a need for an improved system and method to detect network-based attacks against network-connected electronic devices. Such a system and method should be simple, use existing infrastructure, use only the resources and hardware intrinsically available to the electronic device, and without requiring building of data bases that catalog signatures of particular attacks or particular devices prone to attack. It would be desirable if such a system and method filtered out attacks as early as possible in the processing of incoming communications data, e.g., at the link layer in conjunction with the processing of data frames that carry link layer packets.

### SUMMARY OF THE INVENTION

In a preferred embodiment, the invention provides a system and method for filtering packets that are undesirable at a very early stage processing of incoming communications data. The system and method according to the invention filters incoming communications packets in conjunction with the processing of data frames that carry link layer packets. An electronic device operating according to the invention filters incoming packets by receiving a communications packet in a link layer protocol embedded in a data frame protocol on the electronic device; determining a position of a first protocol header in the data frame wherein the first protocol header corresponds to a first protocol packet embedded in the data frame; and successively processing octets in the data frame. In successively processing octets of the data frame, the electronic device processes each octet according to the rules of the data frame protocol; upon processing octets comprising the first protocol header, passing the protocol header to a first protocol packet filter; receiving a first protocol filter result from the first protocol packet filter wherein the first protocol filter result indicates whether the received packet should be dropped according to at least one first protocol filtering rule; and in response to receiving a first protocol filter result indicative that the received packet should be dropped, skipping processing through the end of the data frame.

In a further embodiment of the invention, the electronic device, if the first protocol header contains first protocol options, passes the n octets, the number of octets of options, to a second packet filter for the first protocol. In a further alternative embodiment after filtering according to a first protocol, processing n additional octets of the incoming data, where n is the number of octets required for a next protocol filter, passing the n octets to a packet filter for the next protocol. In response to receiving a filter result from a packet filter indicative that the packet should be dropped, skipping processing of the data frame through the end of the data frame.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a schematic illustration of the operating environment in which a network-connected electronic device according to the invention may be deployed.

FIG. 2 is a schematic illustration of an exemplary architecture of the hardware of a network-connected electronic device 101 that may be used in conjunction with the invention.

FIG. 3 is a schematic illustration of the software architecture implementation for a resource constrained device and a host computer.

FIG. 4 is a schematic illustration of the HDLC frame format.

FIG. 5 is a schematic illustration of the PPP frame format for a PPP packet encapsulated in an AHDLC frame.

FIG. 6 illustrates an example of protocol encapsulations of PPP, IP and TCP in an AHDLC frame.

FIG. 7 is a flowchart illustrating the operation of a software module implementing a first method of packet filtering at the AHDLC level according to the invention.

FIGS. 8 and 9 are flowcharts illustrating the operation of a software module implementing a second method of packet filtering at the AHDLC level according to the invention.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

As shown in the drawings for purposes of illustration, the invention is embodied in a network enabled electronic device, e.g., a network smart card, equipped with the capability of filtering data packets in conjunction with the processing of data frames that carry incoming link layer data packets. The system and method for filtering data packets according to the invention requires no additional hardware resources and very limited additional processing and memory resources and is therefore suitable for use in network-enabled resource-constrained devices, i.e., devices with limited memory, bandwidth, or processing power.

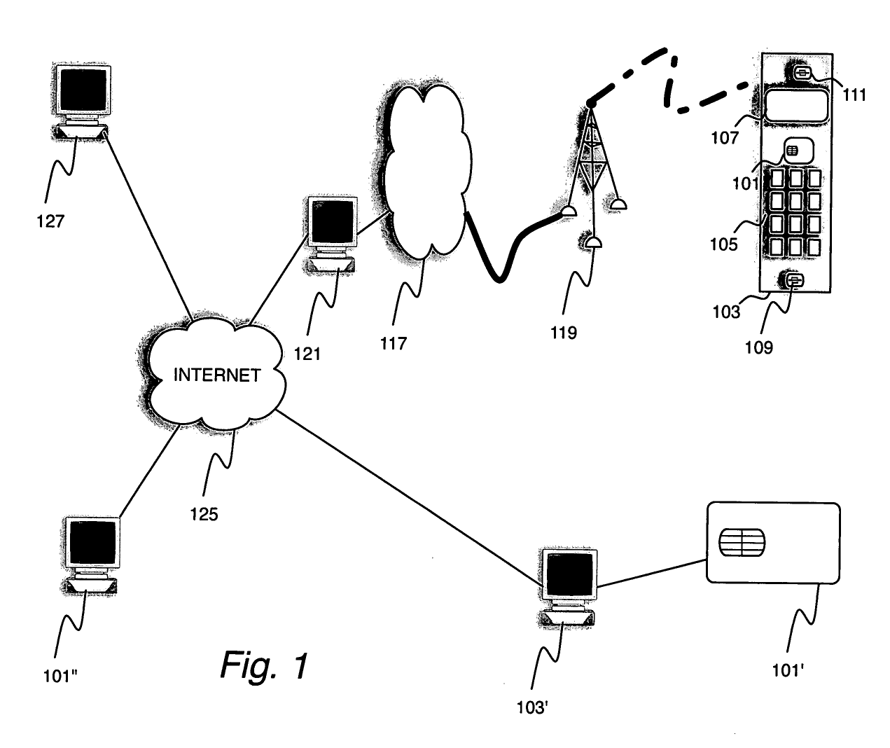

FIG. 1 is a schematic illustration of the operating environment in which a network-connected electronic device according to the invention may be deployed.

In one example, a network-enabled electronic device 101 is a network smart card installed into a handset 103. The handset 103 may be a mobile telephone having the usual accoutrements of a mobile telephone such as a keypad 105, a display 107, a microphone 109 and a speaker 111. In alternative embodiments, the handset 103 may be a personal digital assistant or any other mobile device using a SIM card. The handset 103 also contains an electronic circuitry (not shown) including a central processing unit and memory. Furthermore, there are a variety of smart mobile devices available, such as web-enabled phones, smart phones, PDAs, handheld PCs and tablet PCs. Many of the smart phones and PDAs combine the cell phone and PDA functionalities. Popular operating systems for smart mobile devices include Symbian, Palm OS, and Microsoft Smartphone. The invention described herein is applicable to such devices if they have SIM device that is a network smart card 101.

The electronic circuitry provides communications functionality for the handset 103 with a wireless network 117 via a wireless link to a wireless telephony antenna 119. And the microprocessor provides some of the control functionality of the handset 103, such as managing operations of the handset 103 and managing communications protocols used to communicate with the wireless network 117. The network smart card 101 is connected to the electronic circuitry so as to allow communication between the network smart card 101 and the handset 103.

The wireless network 117 is composed of a complex communications infrastructure for providing connections to other stations, for example, other mobile stations or land-based telephone systems. One such station may be an Internet gateway 121, which gives the wireless network 117 access to the Internet 125. As commonly known, many computers are connected via the Internet. In the scenario presented herein, a user of a handset, e.g., a mobile telephone or a PDA, uses the infrastructure illustrated in FIG. 1 to communicate with the network smart card 101 either via the handset 103 or some other computer connected to the Internet 125. Some aspect of this communication uses direct communication between the network smart card 101 and the remote entity 127, for example, for the purpose of communicating some information that is stored on the network smart card 101 to the remote entity 127.

Another example, of a network-connected electronic-device 101′ is a network smart card having a credit card form factor and which is connected to the Internet 125 via a host computer 103′.

A network smart card 101 or 101′ is a smart card that is capable to act as an autonomous Internet node. Network smart cards are described in co-pending patent application Ser. No. 10/848,738 “SECURE NETWORKING USING A RESOURCE-CONSTRAINED DEVICE”, filed on May 19, 2004, the entire disclosure of which is incorporated herein by reference. A network smart card 101 implements Internet protocols (TCP/IP) and security protocols (SSL/TLS) built into the card and may implement other communications protocols as described herein below. The network smart card 101 can establish and maintain secure Internet connections with other Internet nodes. The network smart card 101 does not depend on a proxy on the host to enable Internet communications. More over, the network smart card 101 does not require local or remote Internet clients or servers to be modified in order to communicate with the smart card.

The invention is also applicable for use in other devices, including other network-enabled resource-constrained devices, and is not necessarily limited in use to resource-constrained devices. For example, a network-enabled electronic-device according to the invention may be a computer 101″. Herein, the term network-enabled electronic-device refers to any electronic device that is connected via a network to other electronic-devices and is capable of communicating electronically with such other devices. Similarly, the reference numeral 101 is used to refer to any such device and not specifically to any one such device.

In the scenario depicted in FIG. 1, an attacking computer 127 is a computer that acts as a source of undesired packets transmitted to the network-connected electronic devices 101. The attacking computer 127, by itself or through reflectors, transmits data packets to the target electronic device 101 with the intent to interfere with the use of some resource, e.g., another resource connected to the Internet, that the target electronic device 101 wishes to access. These communications packets are received and processed by the target electronic device 101.

The network-connected electronic device may be a network smart card, e.g., smart card 101′. Network smart cards, which are described in co-pending patent application Ser. No. 10/848,738 “SECURE NETWORKING USING A RESOURCE-CONSTRAINED DEVICE”, filed on May 19, 2004, the entire disclosure of which is incorporated herein by reference, combine the functionality of traditional smart cards with the capability of acting as autonomous network nodes by implementing a communications protocol stack used for network communication. In the event that the network-connected electronic device 101 connects to the network via a host computer 103′, the host computer 103′ may be the attacking computer, for example, as a reflector or by having some malware installed thereon.

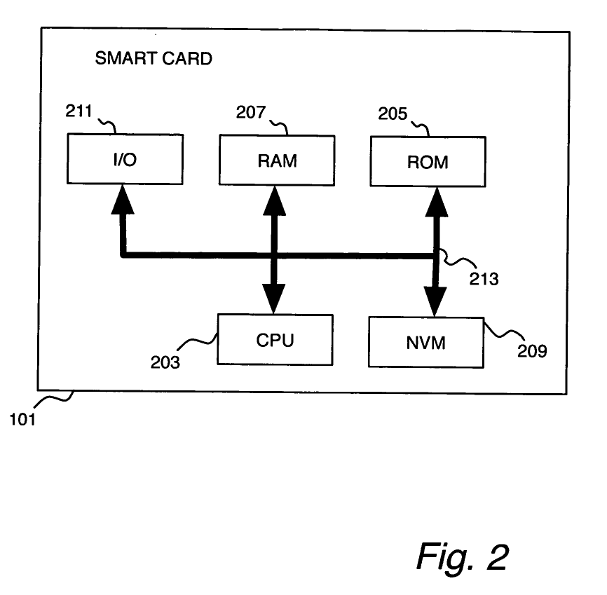

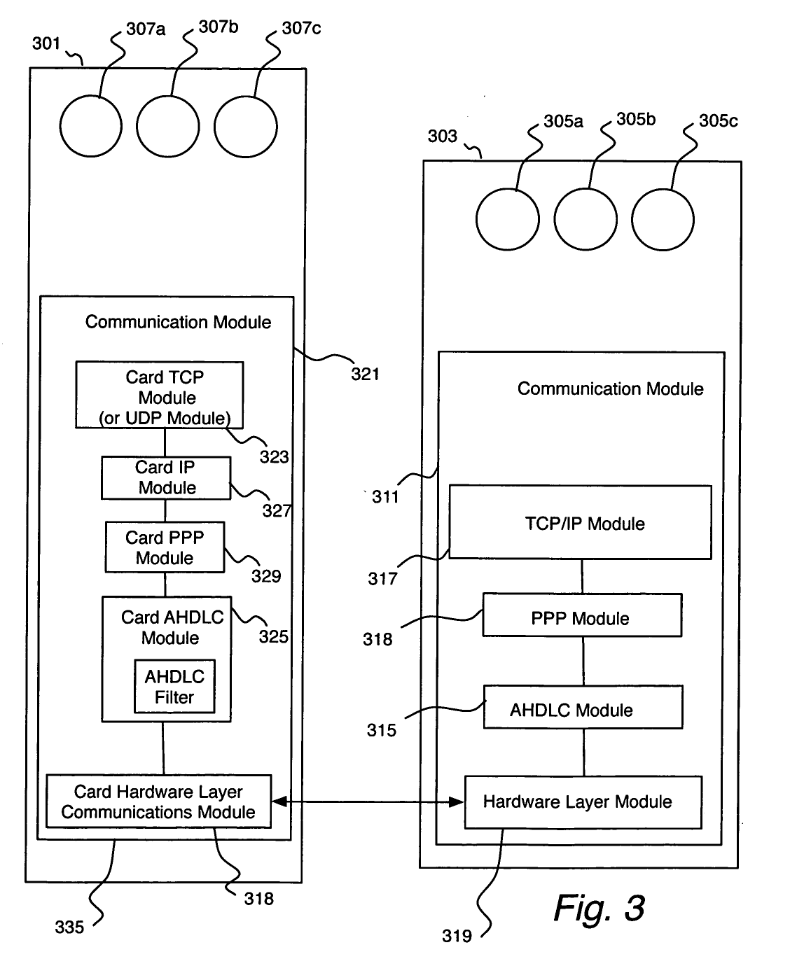

FIG. 2 is a schematic illustration of an exemplary architecture of the hardware of a network-connected electronic device 101 that may be used in conjunction with the invention. The network-connected electronic device 101, according to the example of FIG. 2, has a central processing unit 203, a read-only memory (ROM) 205, a random access memory (RAM) 207, a non-volatile memory (NVM) 209, and a communications interface 211 for receiving input and placing output to a computer network, e.g., the Internet, to which the network-connected electronic device 101 is connected, either directly or via intermediary devices, such as a host computer 103′. These various components are connected to one another, for example, by bus 213. In one embodiment of the invention, a communications module 321 (introduced in FIG. 3 below and described herein below in conjunction with FIG. 3 and other figures herein), as well as other software modules described herein below, would be stored on the resource-constrained device 101 in the ROM 205. In alternative embodiments, the software modules stored in ROM 205 would be stored in a flash memory or other types of non-volatile memory. For purposes of illustration, the invention is described using the ROM example. However, that should not be construed as a limitation on the scope of the invention and wherever ROM is used, flash memory and other types of non-volatile memory can be substituted as an alternative.

The ROM 205 would also contain some type of operating system, e.g., a Java Virtual Machine. Alternatively, the communications module 321 would be part of the operating system. During operation, the CPU 203 operates according to instructions in the various software modules stored in the ROM 205 or NVM 209.

Thus, according to the invention, the CPU 203 operates according to the instructions in the communications module 321 to perform the various operations of the communications module 321 described herein below.

FIG. 3 is a schematic illustration of the software architecture for a resource constrained device 301 and a host computer 303. In the context of FIGS. 1 and 2, the resource constrained device 301 may be the SIM card 101 or a network smart card 101′, and the handset 303 may be the handset 103 or the host computer 103′.

The host computer 303 has loaded thereon several network applications 305a, 305b, and 305c. (Note: In the case of a handset 103, the handset physical architecture is much like that of a computer. Thus, the handset 103 has a memory and a processor. The memory may be composed of RAM, ROM, EEPROM, etc. The memory contains the software modules that control the behavior of the processor. Thus, the various software modules illustrated in FIG. 3 as being part of host computer 303 are usually stored in some non-volatile memory of the mobile device and loaded into the RAM while being executed. From there the software module instructions control the behavior of the processor and causes the mobile device to do certain things, e.g., establish network connections.) Examples of such applications include web browser, and network contacts list application. In the case of a web browser, an application 305a may be used to access the resource constrained device 301, or more accurately, communicate with a web server executing on the resource constrained device 301, e.g., SIM card network application 307a.

The host computer 303 and the resource constrained device 301 communicate over several layers of communication protocols. In one embodiment, these layers may be represented by several communicating software modules, e.g., a TCP/IP Module 317 for handling communications at the TCP/IP level, a PPP module 318 for handling communications at the PPP level, and an AHDLC module 325 for providing communication of data frames that encapsulate PPP packets and, through PPP packets, encapsulate higher level protocol packets. PPP implementations may be built on a restricted subset of the High-Level Data Link Control (HDLC) protocol. HDLC carries out frame formation and frame transmission for PPP. PPP uses one of three framing techniques. For exemplary purposes, an embodiment of the invention using the AHDLC (Asynchronous HDLC), which is asynchronous communication, is described herein.

The host computer 303 may establish connection with the outside data network and may support several applications 305a-c. The application programs on the host computer use a communications module 311 to establish connections to outside network and to communicate with applications 307a-c on the resource constrained device 301.

The communications module 311 contains modules for implementing several communications layers. For example, a TCP/IP module 317 is an implementation of the TCP and IP communications protocols, a PPP module 318 is an implementation of the PPP communications protocol, and the ADHLC Module 315 is an implementation of the AHDLC protocol for receiving and transmitting dataframes that may encapsulate PPP, IP, and TCP packets.

Communication between the resource constrained device 301 and the network via the host computer 303 is described in greater detail in hereinabove referenced co-pending patent application Ser. No. 10/848,738 entitled “SECURE NETWORKING USING A RESOURCE-CONSTRAINED DEVICE”, filed May 19, 2004, which is incorporated herein by reference. The virtual serial port 313 implements the serial port interface that is defined by the operating system of the handset 303. Communication between a network SIM card (also known as a network UICC card) is described in greater detail in co-pending patent application Ser. No. 11/234,577 “COMMUNICATIONS OF UICC IN MOBILE DEVICES USING INTERNET PROTOCOLS,” filed on Sep. 23, 2005, which is incorporated herein by reference.

The AHDLC module 315 is further connected to a Hardware Layer module 319. The Hardware Layer module 319 transmits and receives AHDLC frames over the physical connection to the resource constrained device 301.

In the example of FIG. 3, the network layer is the Internet Protocol (IP). The Ethernet frames carry IP datagrams. In this embodiment, the transport layer is TCP or UDP. IP datagrams carry TCP or UDP messages. In further alternative embodiments, the IP datagrams carry messages in other communications protocols, e.g., ICMP, IGAP, IGMP, RGMP, GGP, IP in IP encapsulation, ST, UCL, CBT, EGP, IGRP, NVP, HMP (See e.g., IP, Internet Protocol, http://www.networksorcery.com/enp/protocol/ip.htm). Once all packets forming a message have arrived to the destination, they are recompiled into the message. In short, the TCP/IP network transmits messages via packets.

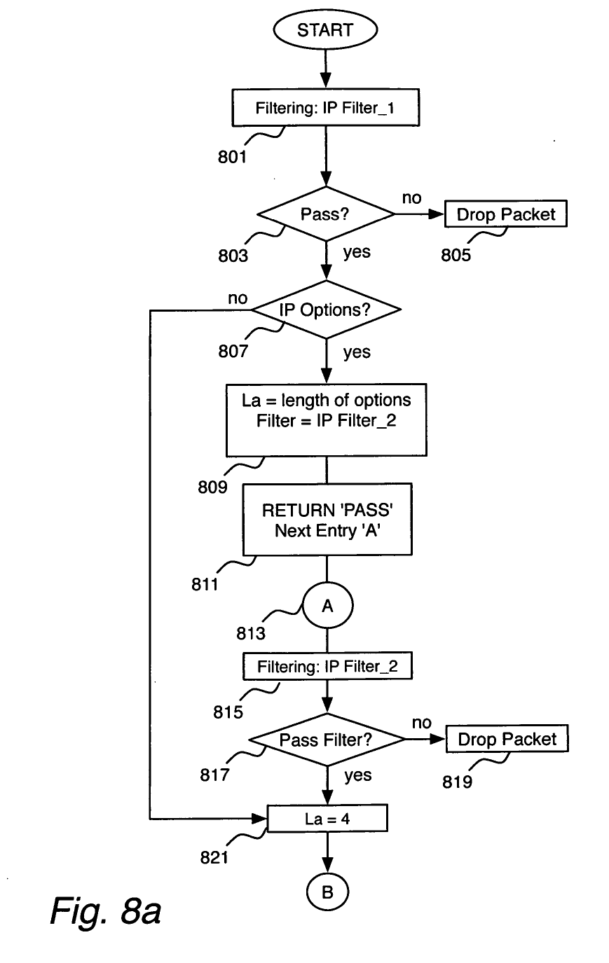

The Card AHDLC module 325, according to the invention, also contains a AHDLC layer filter module 327. The AHDLC filter module contains an implementation of an AHDLC layer packet filter implemented according to the methodologies described herein, for example, in conjunction with FIGS. 7 through 9.

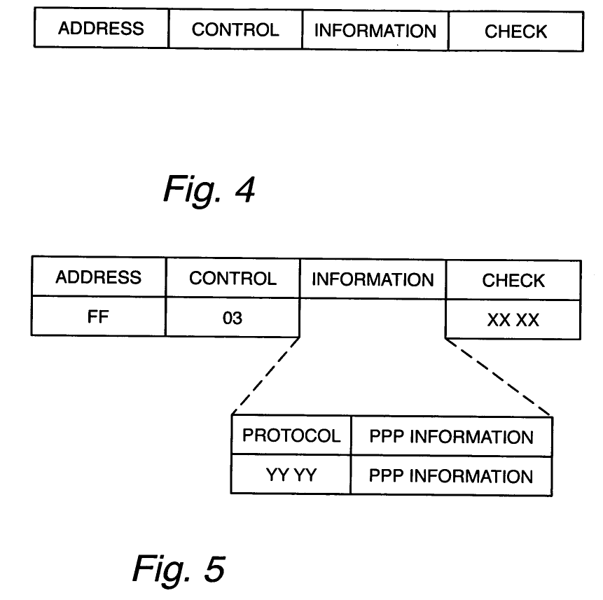

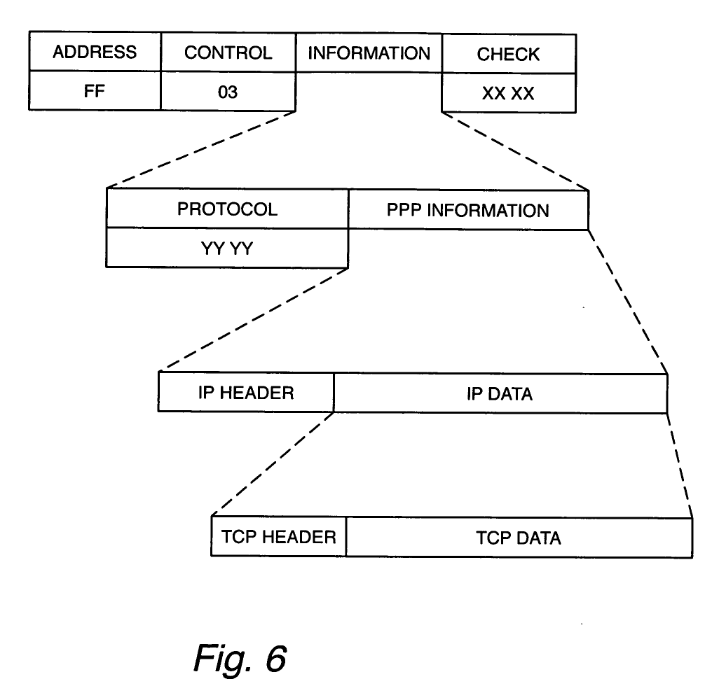

FIG. 4 is a schematic illustration of the HDLC frame format. An HDLC frame consists of three variable length fields (address, control, and information) and one fixed-length field (check) (Calson, J., PPP Design, Implementation, and Debugging, Addison-Wesley, 2000). The check value is usually a standard Cyclic Redundancy Check (CRC) over the preceding three fields. The PPP protocol uses a restricted subset of HDLC. FIG. 5 is a schematic illustration of the PPP frame format for a PPP packet encapsulated in an AHDLC frame. For PPP, the HDLC address field is fixed to the octet FF. The HDLC control field is fixed to the octet 03. The HDLC information field is an integer multiple of 8 bits in length. The CRC is two octets. The information field consists of a two octets long protocol field followed by a PPP information field.

The AHDLC data framing for PPP uses two special octet values that have the hexadecimal values 7E and 7D. The value 7E is a frame delimiter that marks the end of one frame and the beginning of the next frame. The initial 7E is optional. Most implementations, however, start a PPP frame with 7E and end the frame with 7E. The value 7D is an escape character to inform the receiver to form the next actual decoded octet in the HDLC frame as an exclusive-OR of the next transmitted octet with the fixed hexadecimal value 20. The transmitter escapes the values 7D and 7E when sending the PPP frame. By default, all values between 00 and 1F are also escaped by preceding octets with these values with an octet having the value 7D. A special PPP option enables the peers, i.e., in the example of FIGS. 1 and 3, the communications modules 321 and 311, to negotiate values to be escaped. Consequently, the transmitter and receiver process every octet in the AHDLC for possible escape and accumulating CRC. The receiver, in addition, looks for the beginning and the ending of a frame, as indicated by the value 7E.

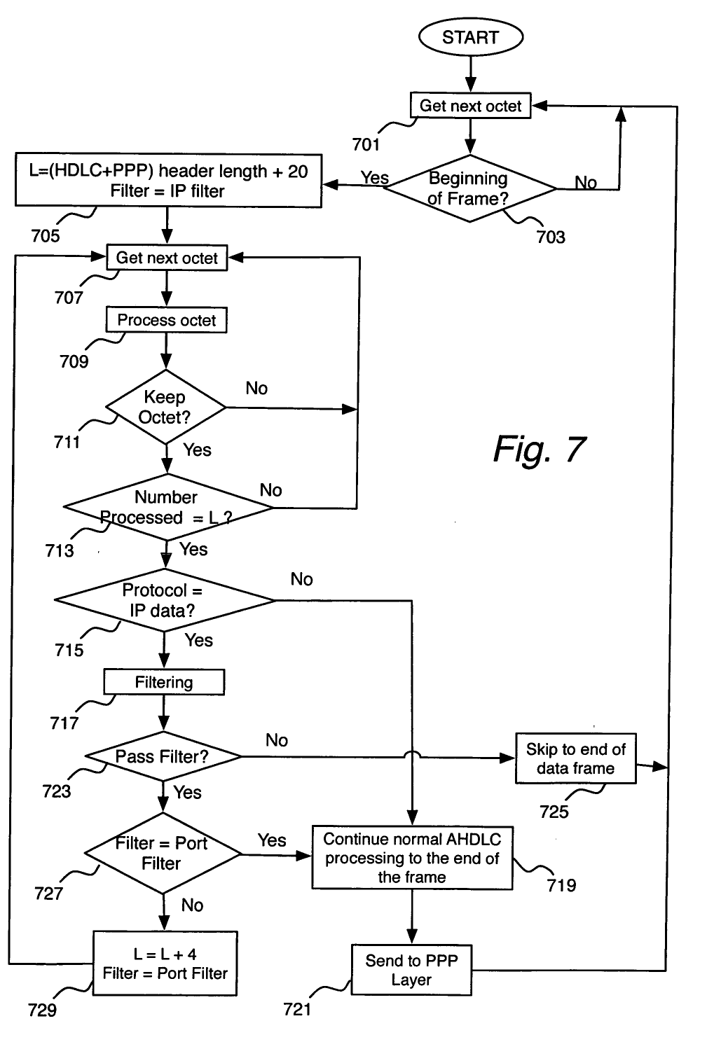

A communication between two nodes using PPP commences with a negotiation process, e.g., including agreeing on escape character. Once the PPP negotiation successfully completes, the PPP packets are used to carry packets of the higher level network protocols. For the Internet protocol case, a PPP frame encapsulates an IP datagram. FIG. 6 illustrates an example of the protocol encapsulations.

The communications packets are typically processed one layer at a time. (The discussion that follows, describes the communication from the vantage point of the resource constrained device 301). After receiving a packet from the I/O hardware 318, the input process starts at the AHDLC layer, i.e., the Card AHDLC Module 325, and then moves relevant data up the communications stack to the higher-level protocol modules, e.g., the PPP module 329, the IP layer module 327 and the TCP module 323. The AHDLC layer module 325 processes one byte at a time from the input buffer and typically puts the result into another buffer. The resulting buffer (or the data in the buffer) is sent to the PPP layer module 329, the IP layer module 327, and the TCP layer module 323 for processing. Data may then be transmitted to the applications 307a-c.

In the prior art, packet filtering is usually performed at IP and TCP layers. Some PPP implementations include packet filtering at the PPP layer as well. This works well for most computers and servers because they have large memories and abundant computing resources. For resource-constrained devices, memory and computing power are very limited. Every effort is made to conserve and to best use the computing resource. Having packets fully processed at AHDLC layer and then dropping them later at upper layer by packet filters waste time and memory. According to the invention, packet filtering is performed at the AHDLC layer to save time and memory usage and, at the same time, provide better network security to the device.

The present invention presents a method and system for packet filtering at the AHDLC layer that may be realized, for example, in implementations of one of two alternative embodiments referred to herein as the Simple Method and the Filter Chain Method, respectively.

FIG. 7 is a flow-chart illustrating the operation of a software module implementing the Simple Method The AHDLC layer module 325 sequentially processes the incoming data one octet at a time. Thus, the module 325 commences processing by obtaining a next octet of data to process, step 701. After the PPP negotiation finishes, PPP processing enters the opened (connected) state to transmit IP data. During the PPP opened state, the format of the incoming packets is fixed. The PPP protocol number for IP data is 0×0021. The IP header starts at exactly the same position within a PPP frame for each PPP frame. See FIG. 6. The default IP header size is 20 octets, which is most commonly used. The TCP header or UDP header follows the IP header. The simple AHDLC packet filtering method utilizes these facts.

For an incoming AHDLC frame, instead of finishing AHDLC processing and sending the PPP frame to the PPP layer, the AHDLC layer only processes the AHDLC headers, PPP headers and 20 octets into the IP datagram. The number of octets in the AHDLC and PPP headers depends on the compression option. Without compression, the AHDLC and PPP headers contain a total of 4 octets. In that case, after processing 24 octets, the software can check a packet against the IP filtering rules, for example, using the IP addresses, to determine if the packet should be dropped. If so, the AHDLC layer does not need to continue processing the rest of the octets. Rather the AHDLC searches the end of the frame, i.e., by searching for an unescaped octet having the hexadecimal value 7E, and starts to process the next frame. If the packet has passed the IP filter (that is, not dropped), the AHDLC layer processes and obtains another 4 octets to obtain the transport layer port numbers. The AHDLC layer then checks the transport layer-filtering rules, for example, using the port numbers, to determine if the packet should be dropped. If so, it stops processing octets, searches the end of the frame, and starts to process the next frame. FIG. 7 illustrates an implementation example of this simple AHDLC packet filtering method.

First the AHDLC layer module 325 searches for a first frame by successively getting a next octet, step 701, and comparing that octet against a frame marker, e.g., the value 7E.

Upon detecting a new octet, the AHDLC layer module 325 establishes a value L and a value Filter, step 705. L is set to the location for the next protocol header. In the case of PPP carrying TCP/IP, the next header is the IP header, which is located 20 octets beyond the AHDLC and PPP headers. The first protocol filter to check the packet against is the IP Protocol filter. Thus, the value for Filter is set to ‘IP Filter’.

Next a sequence of octets are obtained, step 707, processed, step 709, checked to determine whether to save an octet in the result buffer for passing to the PPP module, step 711, until the number of octets processed equals the value L, step 713.

If the indicated protocol is ‘IP data’, step 715, the filter indicated by the value Filter is deployed, step 717, otherwise, the rest of the AHDLC frame is processed, step 719, and control (and a result buffer) is passed to the PPP layer module 329, step 721.

If the protocol is ‘IP data’, the frame is passed to the filter, step 717. There are many different filtering rules known in the art. The filter may deploy any such rule that relies on data up through the protocol header. If the filter returns a result that the packet does not pass the deployed filter rule, step 723, the AHDLC module 325 skips past all octets until the end of the data frame (indicated by an unescaped hexadecimal value 7E).

Otherwise, if the Filter value is ‘Port Filter’, step 727 (note: in the Simple Method, in the example of the embodiment illustrated in FIG. 7, the expected values for Filter is ‘IP Filter’, for the first pass through, and ‘Port Filter’, for the second pass through), the filtering according to the method of FIG. 7 has concluded and the rest of the AHDLC frame is processed, step 719, e.g., placed in a result buffer for access by the higher level protocol modules, and passed on to the PPP layer module, step 721.

If the Filter value is not ‘Port Filter’, step 723, that indicates that the port filter has not yet been executed. Then, the L value is incremented by 4, so that the port value can be read from the AHDLC frame and the Filter value is set to ‘Port Filter’. The process then continues with getting the next octet, step 707, until the port has been read as would be indicated in step 713.

This simple method of AHDLC layer filtering method provides several advantages:
1. Better security. The unwanted packets are blocked at the entrance and do not propagate up.
2. Communication performance enhancement. The AHDLC layer drops the unwanted packets early instead of finishing processing them and sending them up. It can quickly go to the next packet and, hence, saves time.
3. Save memory. Typically, the AHDLC layer puts the resulting PPP frame into another buffer that is different from the AHDLC processing buffer. The unwanted packets are dropped early and do not use more buffers.

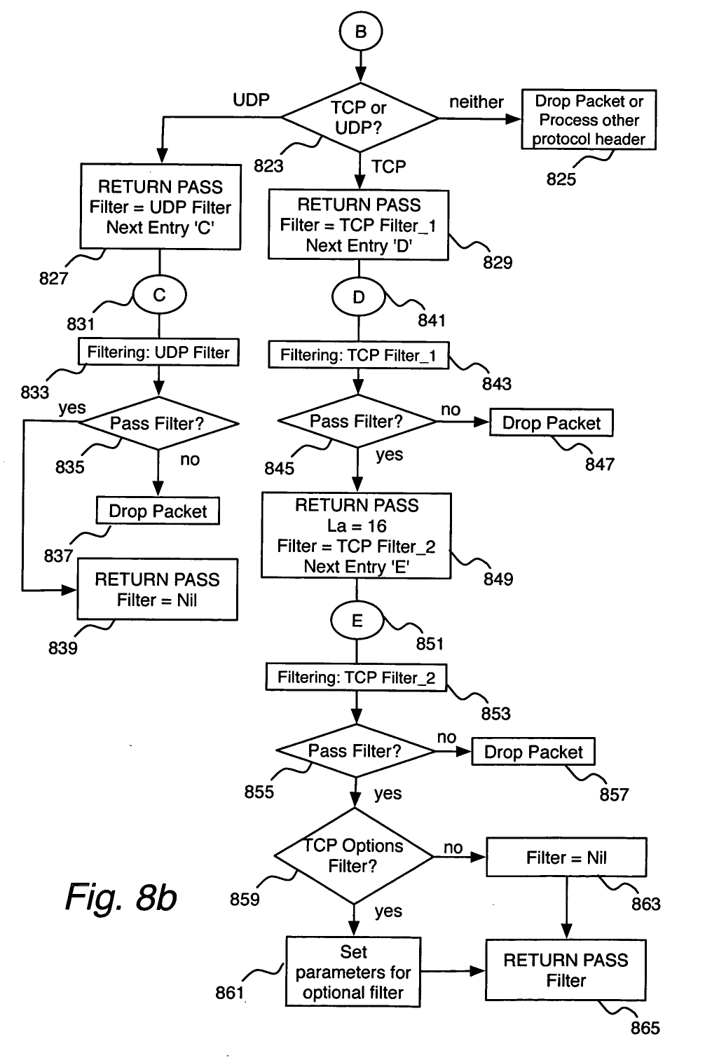

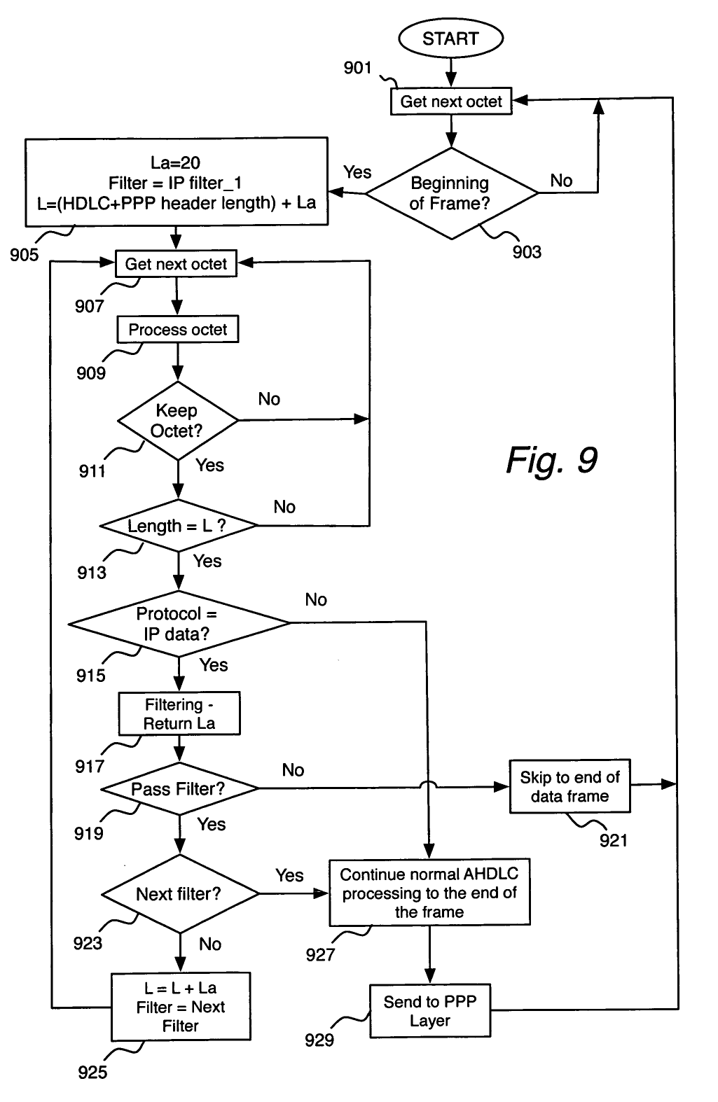

This simple AHDLC packet filtering method assumes that the IP header is 20 octets long. This is true most of the time. However, IP header may contain options. In this case, the header is more than 20 octets long. The filter chain method to be described below in conjunction with FIGS. 8 and 9 solves that problem.

A second alternative embodiment, the Filter Chain Method, is illustrated in the flow charts of FIGS. 8 and 9.

The filter chain method is similar to the simple method but is not limited to the 20 octets default IP header. The UDP or TCP layer module 323 register to IP layer module 327 its packet filter. The IP layer module 327 registers a packet filter (IP Filter_1) to the AHDLC layer module 325. The IP Filter_1 takes the 20 octets IP header, does the filtering, and determines whether to pass or drop the packet. If the packet should be dropped, the process moves on to the next packet. If the packet passes (not dropped), the IP Filter_1 returns a number O and the next packet filter, where the number O indicates the number of additional octets to read.

If the IP header of the packet does not contain options, the number of additional octets to obtain is 4 and the next packet filter is TCP filter or UDP filter. If the IP header contains options, the additional octets to obtain are IP options and the next packet filter is the second IP filter, IP Filter_2. This filter may do filtering using the IP options in a filtering criteria to determine whether to pass or drop the packet. If filtering on IP options is not required or if the IP Filter_2 has not been configured to perform filtering according to IP options, the IP Filter_2 may simply let the packet pass. If the packet does not pass the IP Filter_2, the AHDLC module 325 moves on to process the next packet. If the packet does pass, the IP Filter_2 returns a value 4, which is the number of additional octets to read, and the next packet filter, which might be a TCP filter or UDP filter. The four octets are source and destination port numbers.

The TCP or UDP filter uses the port numbers to check against the filtering rules to decide whether to pass or drop packets. If the packet should be dropped, we go to the next packet. If the packet can pass, a UDP packet will go up the protocol stack from the AHDLC layer; a TCP packet might require more filtering. After a TCP packet passes the first TCP filter, the filter returns the number of additional octets to obtain and the next TCP filter. The next TCP filter may do, for example, state based filtering (or called stateful filtering). FIG. 8 is a flowchart illustrating the dynamic filter chain decision process. FIG. 9 is a flowchart illustrating the operation of an example implementation of the AHDLC packet filtering using the filter chain method.

The method of FIG. 9 presents a loop in which a series of filters are deployed in sequence. The loop consists of processing successive octets and at such times as an appropriate number of octets have been processed to allow a next filter in the series of filter to be deployed, that next filter is invoked. FIG. 8 illustrates the mechanism by which the next filter and the number of additional octets to process prior to invoking the next filter are determined and returned.

Turning first to FIG. 8, the filter chain method maintains two variables, La, of the next protocol header to pass to a filter, and Filter, an identifier for the next filter to invoke. These are initialized (see FIG. 9) and the first filter is applied, step 801. In the embodiment illustrated in FIG. 8, the first filter to apply is a first IP layer filter that operates on the IP header. As in the Simple Method illustrated above, the first 20 octets are read and processed, FIG. 9, step 905 in which the La value is set to 20, and the loop formed by steps 907-913, discussed in greater detail herein below. ).

If the packet does not pass the first filter, step 803, the packet is dropped, step 805.

If the packet passes the first IP layer filter, step 803, then, if the packet contains IP options, step 807, a second IP filter based on those IP options is to be applied, therefore, the La value, the number of octets to advance before invoking the next filter, is set to the length of the options, the Filter value is set to ‘IP Filter_2’ in order to invoke the second IP layer filter, step 809, and an indicator that the packet passed the filter is returned together with the values La, Filter, and the location to which to enter the next time a filter is applied, here ‘A’, step 811.

The next time the filter execute and select logic of FIG. 8 is invoked, that will occur at location ‘A’, location 813. If the filter indicates that the packet did not pass this filter, step 815, the packet is dropped, step 817.

If there are no IP options, step 807, or if the second IP filter passes the packet, step 811, the La value is set to 4, i.e., the number of octets that make up TCP or UDP source and destination port numbers, step 821. A determination is made to determine whether the packet is a TCP, UDP or other kind of packet. As shown in FIGS. 5 and 6, the protocol field of the IP header contains an indicator of which protocol is carried by the data frame. If the packet is neither a TCP nor a UDP packet, step 823, the packet is either dropped or processed according to another communications protocol, step 825. If the packet is a UDP packet, step 823, the next filter to apply is a UDP packet filter based on the UDP source and destination ports. Accordingly, with a return indicator of PASS, the routine returns next filter, Filter, as ‘UDP Filter’, and a next entry point as ‘C’, step 827.

If the packet is a TCP packet, step 823, the packet is filtered using a TCP packet filter based on the TCP source and destination ports. Accordingly, with a return indicator of PASS, the routine returns next filter, Filter, as ‘TCP Filter’, and a next entry point as ‘D’, step 829.

For the UDP Filter, entry point C, location 831, the UDP filter is applied, step 833. f the packet does not pass the filter, step 835, the packet is dropped step 837. Otherwise, an indication that the packet has passed is returned with an indicator (NIL) that no further filtering will be done, step 839.

For the TCP Filter, entry point D, location 841, the TCP filter is applied, step 843. If the packet does not pass the filter, step 845, the packet is dropped, step 847. Otherwise, a second TCP filter, TCP Filter_2, will be employed using the remainder of the TCP header, step 849. Accordingly, an additional 16 octets should be read and processed, i.e., set La to 16, and the next filter entry point to ‘E’.

When the filter selection and invocation routine is next executed, i.e., at entry point ‘E’, location 851, the TCP Filter_2 is executed, step 853. f the packet does not pass the filter, step 855, the packet is dropped, step 857. If the packet passes the TCP Filter_2, further optional TCP filtering may be performed, step 859. In which case, parameters for such filtering is set, step 861. If no further TCP based filtering is to be performed, step 859, the next filter value is set to NIL to indicate that such is the case. Whether more filtering is to be done or not, a value of PASS is returned together with the value for the Filter variable, step 865. If further filtering is to be done using TCP optional filtering, there would be a further entry point and filtering, determination if the filter was passed, and so forth in a similar manner as to that discussed herein above. [0085] It should be noted that many filtering rules exist for TCP and UDP packet filtering. Any such rule may be applied for the UDP Filtering, and TCP Filtering used in steps 801, 815, 833, 843, and 853, respectively.

The filter chain method is dynamic in the sense that the next filter to use is determined according to the information in the received packet. The filter chain method has the same advantages as the simple method including better security, enhanced communication performance, and reduced memory usage. In addition, it removes the 20-octet default IP header assumption and provides more filtering options, for example, TCP stateful filtering. The filter chain method is more general and is more flexible than the simple method.

FIG. 9 is a flowchart illustrating the operation of one example of an implementation of a firewall based on the filter chain method of packet filtering at the AHDLC layer.

In this example, the AHDLC layer module 325 commences by finding the beginning of an AHDLC frame by successively obtaining new octets from the data stream, step 901, until a frame delimiter has been encountered, step 903.

As an initialization step, the AHDLC layer module sets up to filter using a first IP filter, IP_Filter 1, which is a filtering based on the IP header except for options. Because the IP header length without options is 20 bytes long a value La which is used to indicate how many octets to advance for the filter information used by the IP Filter_1 is set to 20. For the initial case, because of the AHDLC and PPP headers, the actual number of octets to be obtained, L, for the IP Filter_1 is incremented by the AHDLC and PPP header length. The next filter variable to be applied, Filter, is initialized to ‘IP Filter_1’, step 905.

Next, for each filter to be applied, L octets are obtained, step 907, are processed as required by AHDLC processing, step 909, if the octet is one that is kept for further processing, step 911, the number of obtained octets is compared to the value L, step 913, to determine if all the octets required for the next filter, Filter, have been obtained.

Once all necessary octets for applying the next filter, Filter, have been obtained, if the protocol, which would have been determined from the protocol field in the PPP header of the data frame, is one for which further filtering may be performed, e.g., it is an Internet protocol such as IP, step 915, filtering is performed by the next filter, Filter, step 917. The filter returns two values, the filter result, i.e., whether the packet passes the filter, and La, the number of octets to advance for the next filter to be applied.

If the packet did not pass the filter, processing is skipped to the end of the AHDLC data frame, step 921.

If there is another filter to apply, step 923, the value L is incremented by the number of additional octets, La, to obtain in order to apply that filter, step 925.

If there are no more filters to apply, e.g., as determined in steps 915 and 923, respectively, the AHDLC module continues processing octets through the end of the data frame, step 927, and the processed data is released to the PPP layer, step 929.

The method and system for filtering data packets according to the invention uses the operations of a communications module to filter incoming data packets during the processing of the link layer. An electronic device incorporating logic implementing or operating according to the method of the invention is highly efficient in that undesirable data packets are eliminated without undue processing at a very early processing stage. The system and method for filtering data packets according to the invention is a general framework for efficient packet filtering and is therefore suitable for use on small resource constrained network devices and may also be deployed on larger systems. The system and method of filtering undesirable packets according to the present invention has several advantages over existing packet filtering systems, including reduced memory usage, and enhanced performance.

Although specific embodiments of the invention have been described and illustrated, the invention is not to be limited to the specific forms or arrangements of parts so described and illustrated. The invention is limited only by the claims.

What is claimed is the following:

1. A method for operating an electronic device, the method operable to filter network packets on the electronic device, comprising:
receiving a communications packet in a link layer protocol embedded in a data frame in a data frame protocol on the electronic device;
determining a position of a first protocol header in the data frame wherein the first protocol header corresponds to a first protocol packet embedded in the data frame;
successively processing octets in the data frame, comprising:
processing the octet according to the rules of the data frame protocol;
upon processing octets comprising the first protocol header, passing the protocol header to a first protocol packet filter;
receiving a first protocol filter result from the first protocol packet filter wherein the first protocol filter result indicates whether the received packet should be dropped according to at least one first protocol filtering rule; and
in response to receiving a first protocol filter result indicative that the received packet should be dropped, skipping processing through the end of the data frame.

2. The method of operating an electronic device of claim 1, further comprising:
in response to receiving a first protocol filter result indicative that the received first protocol packet should not be dropped according to the at least one first protocol filtering rule, determining a second protocol packet header corresponding to a second protocol packet embedded in the first protocol packet;
passing the second protocol packet header to a second protocol packet filter;
receiving a second protocol filter result from the second protocol packet filter; and
in response to receiving a second protocol filter result indicative that the second protocol packet should be dropped, skipping processing through the end of the data frame.

3. The method of operating an electronic device of claim 1 or 2 wherein the link layer protocol is PPP and the data frame communications protocol is the AHDLC protocol.

4. The method of operating an electronic device of claim 1 or 2 wherein the first protocol is IP.

5. The method of operating an electronic device of claim 4 wherein the second protocol is TCP.

6. The method of operating an electronic device of claim 1, further comprising:
receiving from the first protocol filter a next filter octet count indicative of how many octets to pass to a second protocol filter;
processing n octets from the data frame, wherein n is the next filter octet count;
passing the n octets to the second packet filter;
receiving from the second packet filter a second protocol filter result from the second protocol packet filter; and
in response to receiving a second protocol filter result indicative that the second protocol packet should be dropped, skipping processing through the end of the data frame.

7. The method of operating an electronic device of claim 1, further comprising:
receiving from the first protocol filter a next filter octet count indicative of how many octets to pass to a downstream protocol filter;
processing n octets from the data frame, wherein n is the next filter octet count;
if the first protocol header contains first protocol options:
passing the n octets to a second packet filter for the first protocol;
receiving from the second packet filter for the first protocol a second packet filter result; and
in response to receiving a second packet filter result indicative that the first protocol packet should be dropped, skipping processing through the end of the data frame;
if the first protocol header does not contain first protocol options:
passing the n octets to a third packet filter for a second protocol;
receiving from the third packet filter for a second protocol a third packet filter result; and
in response to receiving a third packet filter result indicative that the second protocol packet should be dropped, skipping processing through the end of the data frame.

8. An electronic device, having an instruction memory_containing instructions to cause a processor of the electronic device to filter network packets, the instructions comprising instructions to cause the electronic device to:
receive a communications packet in a link layer protocol embedded in a data frame in a data frame protocol on the electronic device;
determine a position of a first protocol header in the data frame wherein the first protocol header corresponds to a first protocol packet embedded in the data frame;
successively process octets in the data frame, by:
processing the octet according to the rules of the data frame protocol;
upon processing octets comprising the first protocol header, passing the protocol header to a first protocol packet filter;
receiving a first protocol filter result from the first protocol packet filter wherein the first protocol filter result indicates whether the received packet should be dropped according to at least one first protocol filtering rule; and
in response to receiving a first protocol filter result indicative that the received packet should be dropped, skipping processing through the end of the data frame.

9. The electronic device of claim 8, wherein the instructions further comprise instructions to:
in response to receiving a first protocol filter result indicative that the received first protocol packet should not be dropped according to the at least one first protocol filtering rule, determine a second protocol packet header corresponding to a second protocol packet embedded in the first protocol packet;
pass the second protocol packet header to a second protocol packet filter;
receive a second protocol filter result from the second protocol packet filter; and
in response to receiving a second protocol filter result indicative that the second protocol packet should be dropped, skip processing through the end of the data frame.

10. The electronic device of claim 8 or 9 wherein the link layer protocol is PPP and the data frame communications protocol is the AHDLC protocol.

11. The electronic device of claim 8 or 9 wherein the first protocol is IP.

12. The electronic device of claim 11 wherein the second protocol is TCP.

13. The electronic device of claim 8, wherein the instructions further comprise instructions to:
receive from the first protocol filter a next filter octet count indicative of how many octets to pass to a second protocol filter;
process n octets from the data frame, wherein n is the next filter octet count;
pass the n octets to the second packet filter;
receive from the second packet filter a second protocol filter result from the second protocol packet filter; and
in response to receiving a second protocol filter result indicative that the second protocol packet should be dropped, skip processing through the end of the data frame.

14. The electronic device of claim 8, wherein the instructions further comprise instructions to:
receive from the first protocol filter a next filter octet count indicative of how many octets to pass to a downstream protocol filter;
process n octets from the data frame, wherein n is the next filter octet count;
if the first protocol header contains first protocol options:
pass the n octets to a second packet filter for the first protocol;
receive from the second packet filter for the first protocol a second packet filter result; and
in response to receiving a second packet filter result indicative that the first protocol packet should be dropped, skip processing through the end of the data frame;
if the first protocol header does not contain first protocol options:
pass the n octets to a third packet filter for a second protocol;
receive from the third packet filter for a second protocol a third packet filter result; and
in response to receiving a third packet filter result indicative that the second protocol packet should be dropped, skip processing through the end of the data frame.
